(19) United States
(12) Patent Application Publication
(10) Pub. No.: US 2009/0037324 A1
(43) Pub. Date: Feb. 5, 2009

(54) METHOD AND APPARATUS FOR CURRENCY EXCHANGE

(75) Inventors: BRENDAN McLAUGHLIN, Galway (IE); Michael Furey, Galway (IE)

Correspondence Address: WONG, CABELLO, LUTSCH, RUTHERFORD & BRUCCULERI,;L.L.P., 20333 SH 249, SUITE 600, HOUSTON, TX, 77070, US

(73) Assignee: JEMSTONE TECHNOLOGIES LIMITED, Barna Galway (IE)

(21) Appl. No.: 11/833,095

(22) Filed: Aug. 2, 2007

(51) Int. Cl. G06Q 40/00; G06F 17/30; G06F 17/40

(52) U.S. Cl. 705/39

(57) ABSTRACT

A method for exchanging funds between currencies. The method comprises receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency. The plurality of requests are stored in a queue. A request is selected for processing from said queue based upon queue processing data, wherein the selected request is the first request. Data indicating a match between said first and second requests is generated. At least part of said first funds of said first currency is transferred directly from said first party to said second party. At least part of said second funds of said second currency is transferred directly from said second party to said first party.

### FIELD OF INVENTION

The present invention relates to a method and apparatus for exchanging funds from a one currency to another currency.

### BACKGROUND TO INVENTION

Different countries of the world have different currencies. Funds are exchanged between these currencies. Individuals and companies typically wish to exchange funds from and to currencies other than that of the country in which they are mainly resident. Foreign exchange trading has grown from approximately $1 billion per day in 1974 to over approximately $1.9 trillion per day in 2004. This is made up of approximately 240,000 trades each day providing an average trade value of $8,000 per trade.

Unlike a stock market, where all participants have access to common prices, the foreign exchange market is divided up into different levels of access. At a first level is an inter-bank exchange market made up of large investment banking firms. Within this market, an exchange rate between a first currency and a second currency is typically equal to or nearly equal to an exchange rate between the second currency and the first currency. Such exchange rates are usually confidential to the investment banking firms having access to the first level of the market. As one moves to other levels of the market the difference between exchange rate between common currencies in different directions widens. This is primarily due to volumes. For example, there will be relatively small differences between exchange rates in differing directions in transactions between smaller investment banks and large multi-national corporations as compared to differences in exchange rates for small companies and private individuals.

It follows from the above that, at any one time, there are a number of different exchange rates between two currencies depending upon the direction of the currency exchange and the nature of the parties making the exchange. For example, commercial companies often trade in relatively small amounts compared to those of banks and such trades typically have little individual impact on market rates.

The hierarchical nature of the currency exchange market can be problematic. For example, a private individual wishing to exchange funds from US dollars to Euros will carry out the exchange at a first exchange rate. Corresponding transactions from Euros to dollars will be carried out at a second exchange rate. The difference between these exchange rates (known as the spread) is typically absorbed by the banking system covering the banks' costs but also providing the banks with a profit. This is clearly disadvantageous to the parties to the transaction.

It is an object of the present invention to provide a currency exchange method.

### SUMMARY OF INVENTION

According to the present invention, there is provided, a method for exchanging funds between currencies, the method comprising: receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency, storing said plurality of requests in a queue, selecting a request for processing from said queue based upon queue processing data, wherein said selected request is said first request, generating data indicating a match between said first and second requests, transferring at least part of said first funds of said first currency directly from said first party to said second party, and transferring at least part of said second funds of said second currency directly from said second party to said first party.

In this way, funds are transferred directly between the first and second parties without the exchange being facilitated and managed by a bank. Accordingly, both first and second parties can benefit from preferential exchange rates to their mutual benefits.

Queue processing data may be arranged to cause selection of a request at a head of the queue. Such data may be a pointer to an element in the queue. The queue may comprise a First In First Out (FIFO) queue. The method may further comprise ordering the requests in the queue based upon data within the requests. The ordering may be based upon a time at which the requests are made by respective users and/or a time at which the requests are received. At least some of the requests may contain priority data, and the ordering may be based upon such priority data. The priority data can take a number of forms, and may, for example, be based partially upon the identity of the user making the request and/or partially upon a geographic location of the user making the request, and/or the value of the request.

The queue may be a plurality of queues. The method may further comprise storing a plurality of requests in a primary queue and moving each of the requests to one of a plurality of second queues based upon data associated with a particular request. The method may comprise selecting one of the second queues to which a request should be moved based upon a source and/or destination currency of the request.

The plurality of second queues may comprise a first relatively high priority queue and a second relatively low priority queue. The method may comprise selecting one of the second queues to which a request should be moved based upon a priority of the request.

The queue may be a plurality of queues comprising a plurality of first queues and a plurality of second queues. Requests may be stored in a selected one of the first queues and such requests can be processed to determine a second queue into which requests in the first queue should be transferred. The first queue may be selected based upon a source currency of a particular request. The second queue may be selected based upon a destination currency and/or source currency of a particular request.

The first request may specify a first amount in the first currency, and the second request may specify a second amount in the second currency. The method may comprise processing a plurality of requests to determine a match between at least two requests. The at least two requests may comprise the first request and the second request.

Processing the plurality of requests to determine a match may comprise determining:
(i) whether a source currency of a third request is a destination currency of a fourth request; and
(ii) whether a source currency of the fourth request is a destination currency of the third request.
   A match may be determined if but only if conditions (i) and (ii) are satisfied.

The third and fourth requests may specify corresponding amounts. The corresponding amounts may be specified in different currencies with reference to an exchange rate. The exchange rate may be a variable exchange rate varying based upon market trends and the nature of the parties to a particular exchange. The third request may be matched with a plurality of fourth requests. The third request may specify an amount corresponding to an amount of said plurality of fourth requests. Correspondence may be defined with reference to an exchange rate which may be as described above.

The method may be carried out by a server connected to a computer network. Requests may be transmitted to the server over the computer network. The requests may be generated by a plurality of user terminals connected to the computer network.

The invention further provides, a computer program configured to cause a computer to carry out a method for exchanging funds between currencies, the method comprising: receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency, storing said plurality of requests in a queue, selecting a request for processing from said queue based upon queue processing data, wherein said selected request is said first request, generating data indicating a match between said first and second requests, transferring at least part of said first funds of said first currency directly from said first party to said second party, and transferring at least part of said second funds of said second currency directly from said second party to said first party.

A computer readable medium may carry the computer program set out above.

There is further provided, a computer apparatus for exchanging funds between currencies, the apparatus comprising: a program memory storing processor readable instructions, and a processor configured to read and execute instructions stored in said program memory, wherein said processor readable instructions comprise instructions controlling the processor to carry out a method for exchanging funds between currencies, the method comprising: receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency, storing said plurality of requests in a queue, selecting a request for processing from said queue based upon queue processing data, wherein said selected request is said first request, generating data indicating a match between said first and second requests, transferring at least part of said first funds of said first currency directly from said first party to said second party, and transferring at least part of said second funds of said second currency directly from said second party to said first party.

It will be appreciated that all aspects of the present invention can be implemented by way of methods and apparatus. Such apparatus includes suitably programmed computers. Accordingly, the invention also provides suitable computer programs which may be carried on appropriative computer readable media. Such media include both tangible media (e.g. CD-ROMs and DVDs) and intangible media (for example communication signals).

### BRIEF DESCRIPTION OF DRAWINGS

Embodiments of the present invention will now be described, by way of example, with reference to the accompanying drawings, in which:

FIG. 1 is a schematic illustration of a prior art currency exchange process;

FIG. 2 is a schematic illustration of a currency exchange process;

FIG. 3 is a flowchart showing processing carried out in the process shown in FIG. 2;

FIG. 4 is a schematic illustration of a computer network;

FIG. 5 is a flowchart showing processing carried out in a currency exchange process implemented on the network of FIG. 4;

FIG. 6 is a schematic illustration of part of the data stored in the database showing FIG. 4;

FIGS. 7 and 8 are flowcharts showing processing carried out by a server in the network of FIG. 4;

FIG. 9 is a schematic illustration of a currency exchange request;

FIG. 10 is a schematic illustration of a queuing scheme implementable in the processing of FIGS. 7 and 8;

FIG. 11 is a flowchart showing operation of the queuing scheme of FIG. 10;

FIG. 12 is a schematic illustration of a further queuing scheme implementable in the processing of FIGS. 7 and 8;

FIG. 13 is a schematic illustration of a further queuing scheme implementable in the processing of FIGS. 7 and 8;

FIG. 14 is a schematic illustration of a modification to the queuing schemes of FIGS. 10, 12 and 13; and

FIG. 15 is a schematic illustration of a further modification to the queuing schemes of FIGS. 10, 12 and 13;

### DESCRIPTION OF EMBODIMENT

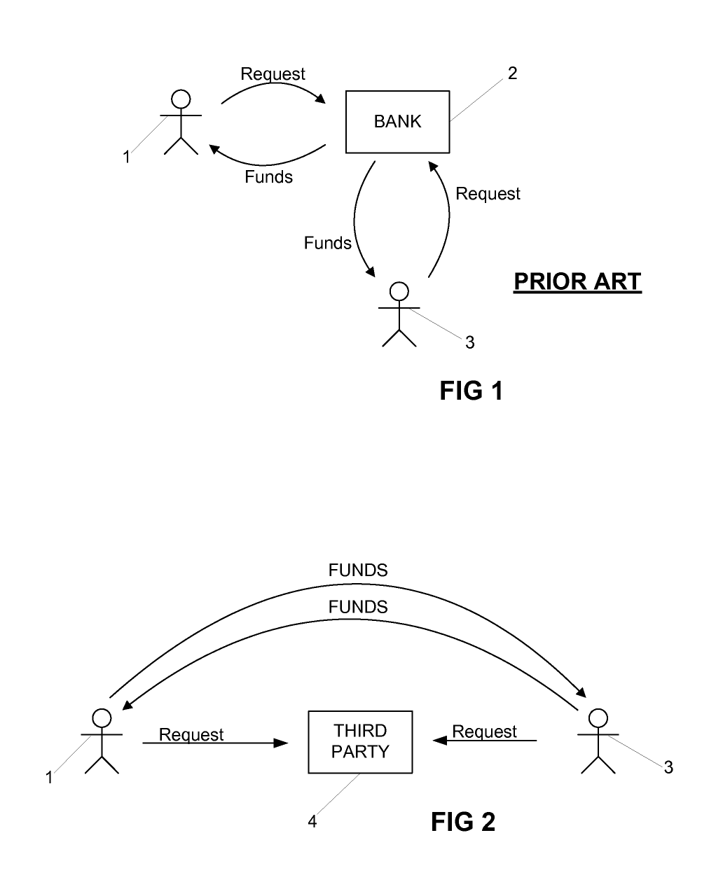

With reference to FIG. 1, a known currency exchange process is described. A first party 1 makes a request to a bank 2 for currency exchange. For example, the first party 1 may make a request by requesting the conversion of a specified amount in a first currency into a corresponding amount in a second currency. The bank 2 calculates the corresponding amount in the second currency with reference to an appropriate exchange rate and provides funds in the second currency of the calculated amount. The request can take the form of the first party providing the specified amount of the first currency to the bank either in cash or by way of an instruction to debit a particular bank account in which funds are held in the first currency. Similarly, provision of the funds in the second currency can either take place by the provision of cash of the second currency or an appropriate credit of a bank account in which funds are held in the second currency. Instead of specifying an amount in the first currency which is to be converted into a corresponding amount in the second currency, the first party 1 can instead specify an amount in the second currency, whereupon the bank 2 calculates an appropriate amount in the first currency and receives the appropriate amount in the first currency either in cash or by debit of an appropriate bank account.

FIG. 1 further shows a second party 3 who wishes to exchange funds in the second currency for funds in the first currency (i.e. the reverse of the exchange carried out by the first party 1). The second party 3 and the bank 2 undertake interactions equivalent to those described above with reference to the first party 1 and the bank 2, allowing the second party 3 to obtain the required funds in the appropriate currency. However it is to be noted that although the first and second parties 1, 3 are exchanging between the same two currencies (but in opposite directions) the exchange rates applied by the bank 2 to the two transactions are different. This is because the bank 2 buys a particular currency at a first exchange rate and sells that currency at a second different rate. The difference between the first and second exchange rates covers the bank's costs of carrying out currency exchange, allows mitigation against changing market exchange rates, and provides the bank 2 with a profit.

The arrangement shown in FIG. 1 is typical of the way in which a private individual exchanges currency when visiting a foreign country. For example, a US resident visiting Europe will often exchange dollars for euros before travel, by using a bank or bureau de change at an airport in the manner described above. The arrangement of FIG. 1 is also typical of the way in which companies carry out currency exchange when handling business transactions involving more than one currency. In the case of companies, the funds will typically be transferred directly between two bank accounts held by a particular company rather than any cash physically changing hands.

FIG. 2 is a schematic illustration of an alternative currency exchange arrangement. It can be seen that the first party 1 and the second part 3 interact with a third party 4 (which may be a bank) to allow currency exchange to take place. However, instead of each of the first party's transaction and the second party's transaction being handled independently of one another (as was described with reference to FIG. 1), the transactions are matched. That is, assuming for simplicity that the first and second parties wish to exchange corresponding amounts, the first party's first currency amount is provided directly to the second party, while the second party's second currency amount is provided directly to the first party. It can therefore be appreciated that both transactions are based upon a common exchange rate, that exchange rate being more favourable for each of the first and second parties than the differential exchange rates used in the system of FIG. 1. The funds to be transferred are not transferred to or from the third party 4 but are instead passed directly between the first party 1 and the second party 3. The third party 4 charges a fee for matching the first party 1 and the second party 3, and providing an infrastructure which allows the transaction to be carried out.

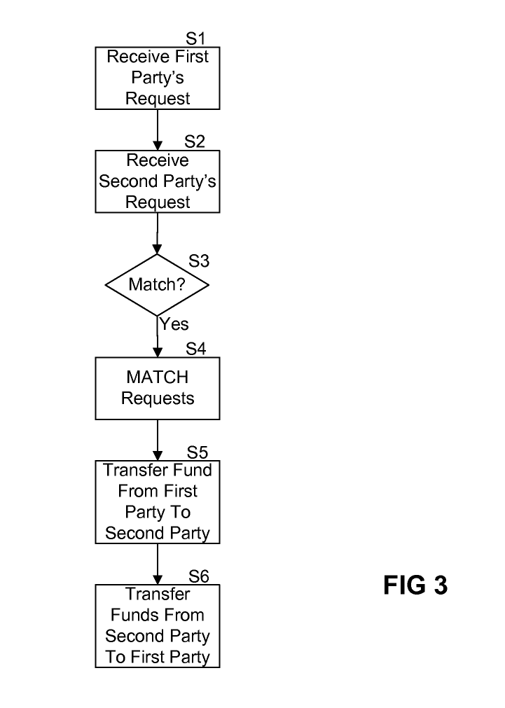

FIG. 3 is a flowchart showing processing carried out by the third party 4 in the arrangement of FIG. 2. At step S1 the first party's request is received, while at step S2 the second party's request is received. In the presented example it is assumed that the first and second parties' requests match. That is, it is assumed the amount which the first party wishes to exchange in a first currency for a second currency exactly matches the amount which the second party wishes to exchange in the second currency for an amount in the first currency. At step S3 a check is carried out to determine whether a match has occurred, and if this is the case, processing passes to step S4 where the first and second party's requests are matched. At step S5 funds in the first currency are transferred directly from the first party to the second party. At step S6 funds in the second currency are transferred directly from the second party to the first party.

It will be appreciated that in many cases the first and second parties 1, 3 will not wish to exchange exactly corresponding amounts. It will also be appreciated that there will typically be a larger number of parties making currency exchange requests to the third party 4. The third party 4 therefore provides ways of matching more than two parties so as to allow exchanges to be carried out in the manner described. This is described in further detail with reference to an embodiment described below.

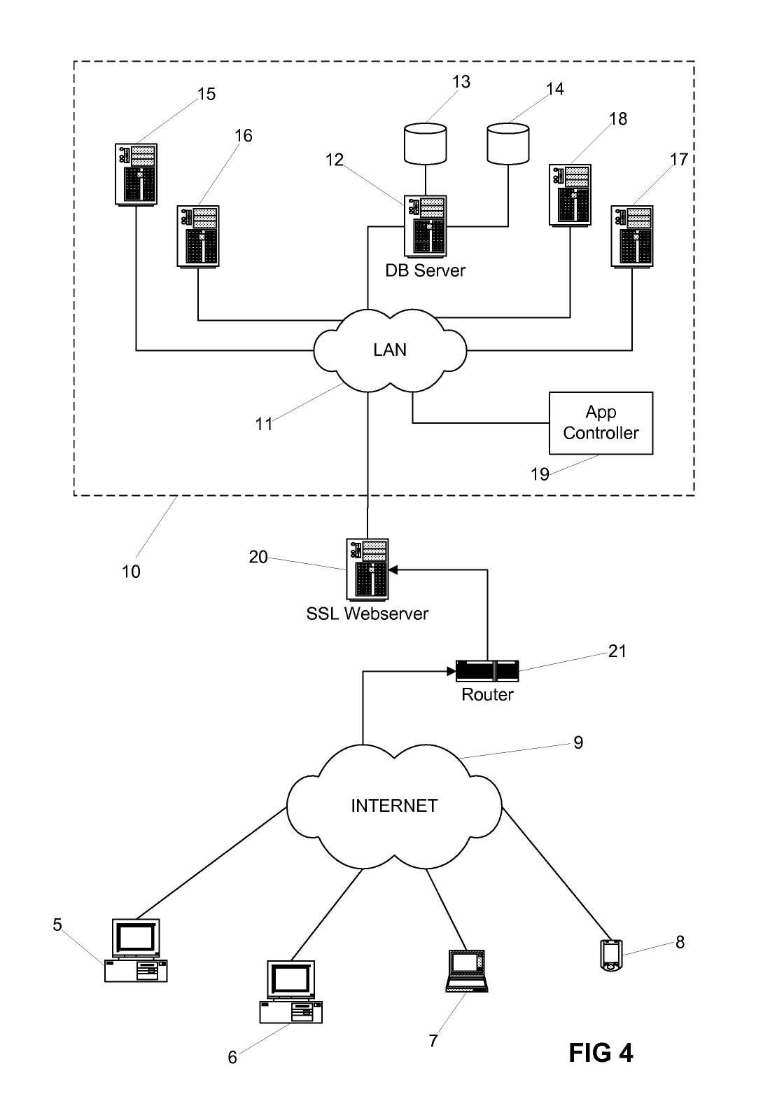

FIG. 4 is a schematic illustration of a computer network on which an embodiment of the invention can be implemented. It can be seen that a plurality of user terminals in the form of PCs 5, 6, a laptop computer 7 and a personal digital assistant 8 are connected to the Internet 9. The connections between the user terminals and the Internet 9 can be provided in any convenient way. For example, the PCs 5, 6 and the laptop computer 7 may be provided with network interfaces allowing access to a local area network (not shown) to which a computer having a connection to the Internet is connected. In this way, the PCs 5, 6 and the laptop computer 7 are provided with access to the Internet 9 via the local area network and the computer having a connection to the Internet. Alternatively, the PCs 5,6 the laptop computer 7 and the PDA 8 may be provided with modems allowing communication between the respective user terminal and a server computer having Internet connectivity. The term modem is used not only to cover devices providing dial up access to the Internet, but also to cover devices which provide relatively high-bandwidth connections to the Internet, generally known as broadband connections. In general terms, it will be appreciated that the user terminals can be connected to the Internet 9 in any convenient way, and such methods of connection will be apparent to an ordinarily skilled person.

A server network 10 comprises a local area network 11 to which a plurality of computing devices are connected. Specifically, a database server 12 is connected to the local area network 11. The database server 12 manages a first database 13 and a second database 14. Data is stored for use in the first database 13, and a backup copy of that data is made by the database server 12 and stored in the second database 14. A plurality of application servers 15, 16, 17, 18 are also connected to the local area network 11. Each of the application servers 15, 16, 17, 18 provide essentially the same functionality, however the provision of a plurality of such servers allows load balancing to be carried out between the servers so as to ensure that there is sufficient processing power available at a given time. An application controller 19 is also connected to the local area network 11 and allows requests for particular services to be directed to an appropriate one of the application servers 15, 16, 17, 18. A webserver 20 is connected to the local area network 11 and also to a router 21 which provides a connection to the Internet 9. It will be appreciated that in some embodiments the webserver 20 may be a plurality of webservers.

The webserver 20 provides webpages which can be requested by users of the user terminals. Such requests are forwarded to the webserver 20 through the Internet 9 and the router 21. The webserver 20 responds to such requests by providing appropriate webpages to the user terminals, again by way of the router 21 and the Internet 9. The webpages provided by the webserver 20 comprises static webpages stored by the webserver 20 and provided in response to appropriate requests. The provided webpages also include dynamically created webpages. That is, some pages are created by the webserver 20 making appropriate requests to one of the application servers 15, 16, 17, 18 (perhaps via the application controller 19), and the application servers 15, 16, 17, 18 responding by providing appropriate information to the webserver 20.

Such appropriate information may be obtained by one of the application servers 15, 16, 17, 18 from the database server 12. In this way, the webserver 20 is able to provide both static and dynamic webpages to the user terminals connected to the Internet 9.

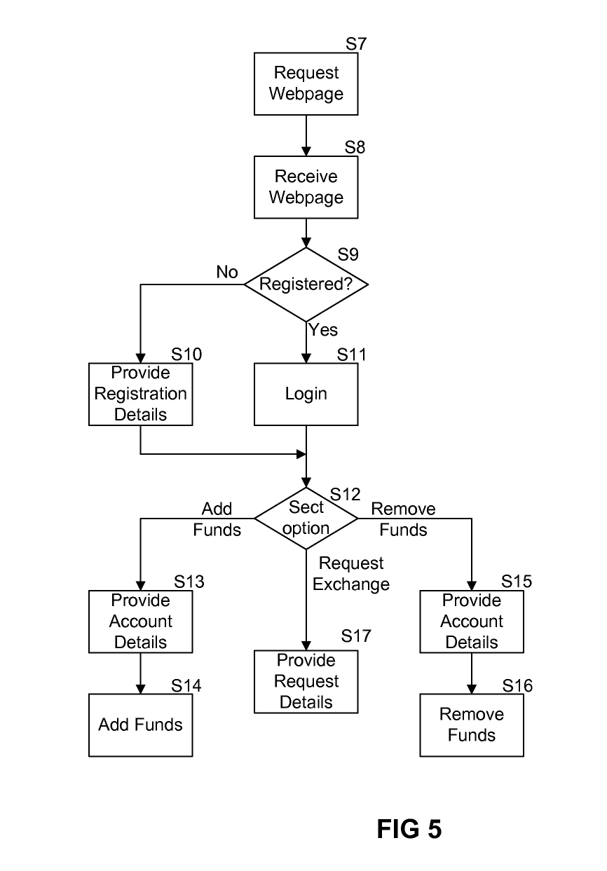

A currency exchange process is now described. First, operations carried out by a user operating one of the user terminals of FIG. 4 are described with reference to a flowchart shown in FIG. 5. At step S7 a user requests an appropriate webpage from the webserver 20. This request is made by using web browser software which runs on the respective user terminal. The request is processed by the webserver 20, and an appropriate webpage is provided from the webserver 20 to the user terminal. The webpage is received by the user terminal at step S8. At step S9, if the user has not registered with the operator of the webserver, processing passes from step S9 to step S10 where a webpage suitable for receiving appropriate registration details is requested from the web server 20, received by the respective user terminal and displayed to the user. The webpage includes a plurality of fields into which appropriate details are entered. Such registration details will include personal details identifying the user such as name and address details, telephone numbers and an email address. Personal details will also include a username and password identifying the user so as to allow the user to appropriately access the system without re-registering in the future. Financial information relating to bank accounts held by the user can also be entered at step S10. The user will also specify currencies between which it is desired to carry out currency exchange transactions. It is preferred that details of a bank account are provided for each currency in which a user intends to carry out currency exchange transactions. Having completed the fields provided by the webpage, the information entered is transmitted from the user terminal to the webserver 20, from where it is forwarded to one of the application servers 15, 16, 17, 18 before being passed to the database server 12 for storage in the first database 13. The transmission of information from a user terminal to a webserver in this way will be familiar to a person skilled in the art, as will appropriate methods for implementation of such transmission.

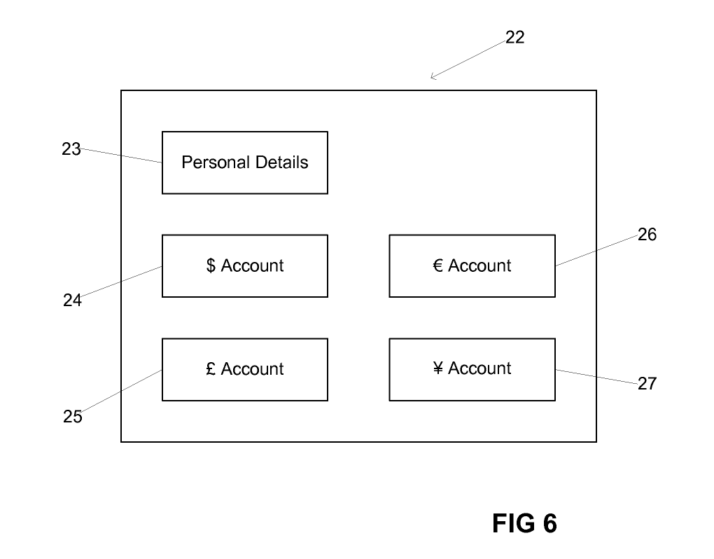

FIG. 6 is a schematic illustration of data 22 stored in the first database 13 (a copy which may be stored in the second database 14 for purposes of backup) for a particular user. The data includes personal details 23 of the type described above provided by the user by appropriate completion of a form provided by way of a webpage. The data further includes data relating to an account for each of the currencies specified by the user during registration. Such accounts are held within the system and used for currency exchange transactions. That is, in the described example, the user specified a wish to carry out transactions involving US dollars, Euros, UK Pounds Sterling, and Japanese Yen, such that data relating to a dollar account 24, a pound account 25 a Euro account 26 and a Yen account 27 is stored. It will be appreciated that the data 22 can be stored in the databases 13, 14 in any suitable way. For example, each of the databases may be a relational database in which data is stored in a plurality of tables between which appropriate relationships are defined. Appropriate methods for the storage of such data in the databases will be readily apparent to an ordinarily skilled person.

Referring back to FIG. 5, having completed a registration process of the type described above at step S10, processing passes to step S12 where a user can make an appropriate selection of an operation to be carried out, as described further below. If, however, at step S9 the user is already registered, an appropriate option may be selected within a displayed webpage, causing processing to move from step S9 to step S11 where appropriate login details (for example a username and password) are entered and transmitted to the server network 10 for verification, preferably using appropriate encryption such as SSL encryption. In some embodiments particular users are only able to use particular terminals so as to limit access. Assuming successful verification, processing then continues at step S12.

At step S12 a user is able to select (by selecting an appropriate option from a webpage) one of a plurality of operations to be carried out. A user can choose to add funds to an account within the system which is held in a particular currency and used for currency exchange transactions. Such accounts for one user are shown in FIG. 6. If this option is selected, processing passes from step S12 to step S13. Here a user specifies an account external to the system from which funds should be transferred. Where a user specifies details of such an external account during the registration process described above, such details may be obtained for use in the transfer operation carried out at step S13. Alternatively a user may enter details of a credit or debit card which is to be used to provide funds which are to be added to an account within the system. Funds are added to an account within the system at step S14.

At step S12 a user can alternatively select to perform a reverse operation. That is to transfer funds from an account within the system to an account external to the system. In this case processing passes from step S12 to step S15 where details of an appropriate external account are specified, and a removal of funds then takes place at step S16.

At step S12 a user can also provide details of a currency exchange request. Such a request can be made in respect of funds held within an account within the system. That is, where funds are held in the US dollar account 24, a user can request the exchange of those funds for funds in any other currency for which the user has an account within the system. Such a request is forwarded to the webserver 20, and processed in a manner described in further detail with reference to subsequent figures.

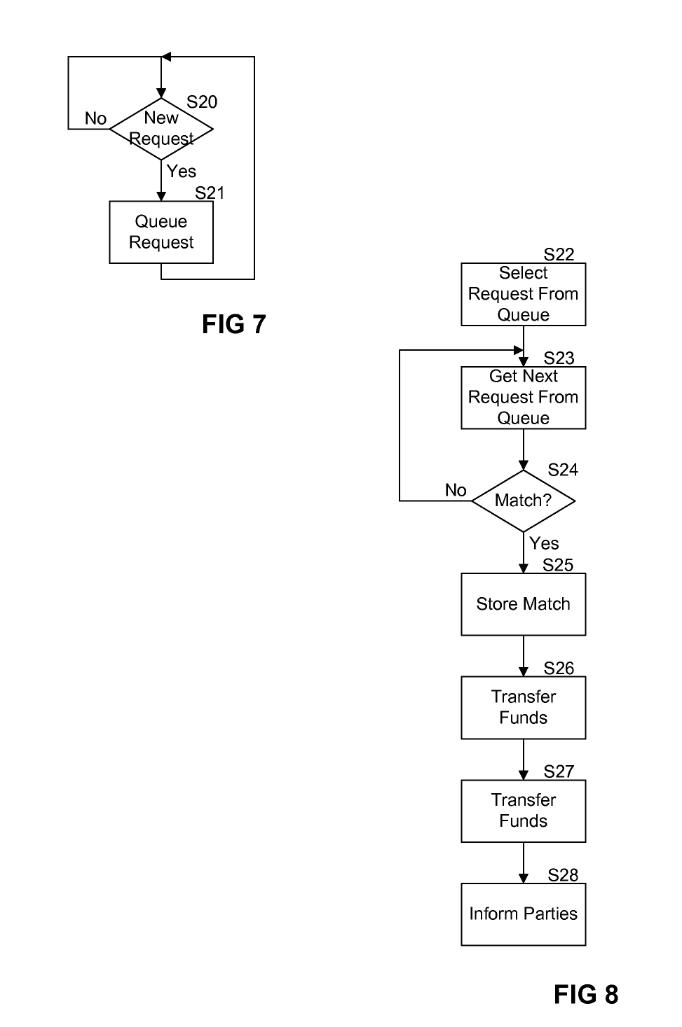

FIGS. 7 and 8 are flowcharts showing the processing of currency exchange requests by one of the application servers 15, 16, 17, 18 (FIG. 4). Such requests are provided to one of the application servers by the webserver 20, using methods described above. FIG. 7 shows processing carried out by an application server in response to a currency exchange request. A process waits at step S20 until an appropriate request is received. When such request is received it is queued at step S21 and processing returns to step S20. Suitable Queuing methods are described in further detail below.

FIG. 8 shows processing of queued requests. At step S22 a request to be processed is selected in accordance with the queuing method used. A further request to be processed is then selected at step S23, and a check is carried out at step S24 to determine whether a match is found. A match can be defined in a number of ways, and these are described in further detail below. If the request selected at step S23 does not match that selected at step S22, processing returns from step S24 to step S23 where a further request is selected for processing. When a match is located, processing passes from step S24 to step S25. At step S25 data is stored indicating that a match has been found, before funds are transferred from an account of a first party within the system to an account of a second party within the system at step S26. A corresponding transfer is carried out at step S27, where funds are transferred from an account of the second party within the system to an account of the first party. At step S28, the parties are informed that funds have successfully been exchanged. The parties can be informed at step S28 in any convenient way using any contact information provided during the registration process described above, or alternatively using contact information provided with the request. For example, the parties can be informed at step S28 by email, SMS message, telephone or letter, although electronic communication by email or SMS message is typically preferable being instantaneous and requiring no human involvement.

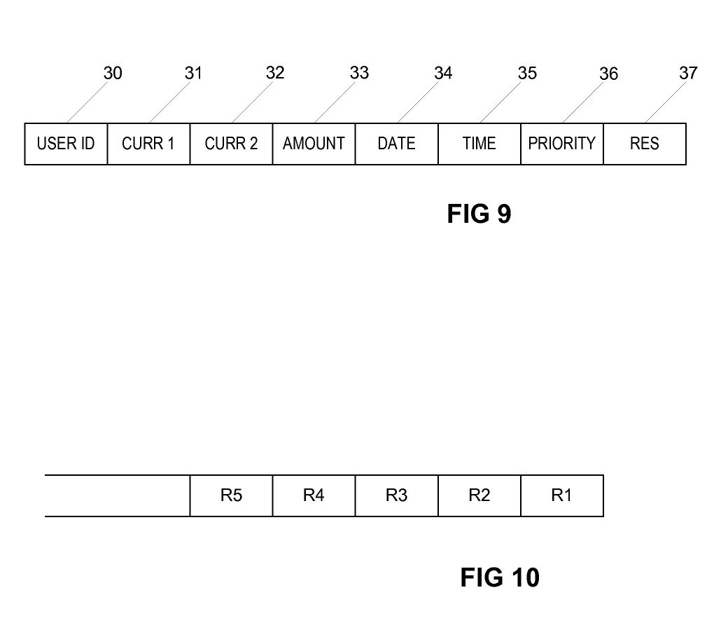

A currency exchange request can take any convenient form. One such form is shown in FIG. 9. Here, a currency request comprises an identifier 30 identifying a user making the request, a source currency 31 from which funds are to be transferred and a destination currency 32 into which funds are to be transferred. An amount in the source currency 33 together with a date 34 and time 35 associated with the request are also included in the currency request. The request further comprises a priority code 36, thereby allowing requests made by particular users, for example high volume users, to be prioritised over requests made by other users. A reserved field 37 is also provided, which is used in varying ways depending upon the queuing method employed, as discussed below.

Queuing methods used in the processes of FIGS. 7 and 8 are now described. FIG. 10 is a schematic illustration of a queue of currency exchange requests. The illustrated queue has five elements denoted R1, R2, R3, R4 and R5. When a new request is received it is added to the tail of the queue, that is a further request would be added following element R5. The processing of step S21 of FIG. 7 is therefore straightforward. Processing of the queue begins at the head of the queue, that is with the element denoted R1.

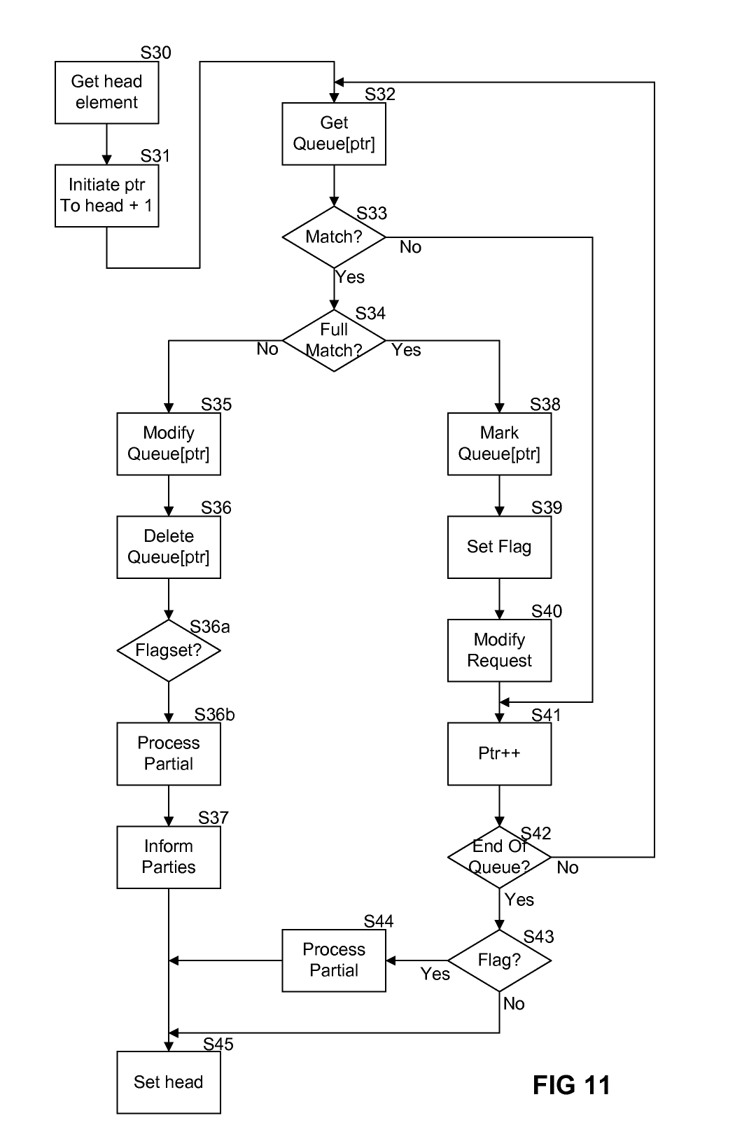

FIG. 11 is a flowchart showing how requests represented by elements of the queue of FIG. 10 are processed. At step S30 the element R1 at the head of the queue is retrieved for processing. A queue pointer is then initialised to point to an element immediately following the head element R1 at step S31. That is, the pointer is initialised to point to the element R2. The element of the queue indicated by the pointer is retrieved at step S32 for processing. At step S33 a check is carried to determine whether the requests retrieved at steps S30 and S32 match. A pair of requests can match only if the source currency of one request is the destination currency of the other request and vice versa. If this is the case, processing passes to step S34 where a check is carried out to determine whether the request retrieved at step S32 is sufficient to satisfy the whole of the request at the head of the queue retrieved at step S30. That is, a check is carried out to determine whether the request retrieved at step S32 is in respect of funds not less than the funds involved in the request referred at step S30. If this is the case, it can be seen that the request at the head of the queue (retrieved at step S30) is fully satisfied by the request at the position in the queue indicated by the pointer (retrieved at step S32).

If the check of step S34 is satisfied, processing passes to step S35 where appropriate modification is made to the request retrieved at step S32. In the case that the request retrieved at step S32 is fully satisfied by the request at the head of the queue, it will be appreciated that both parties' requests are satisfied, such that the request retrieved at step S32 should be removed from the queue. Where the queue is implemented as a linked list, removal of an element from the queue can be easily achieved by suitable pointer modification. If however the request retrieved at step S32 is not fully satisfied by the request at the head of the queue, the request retrieved at step S32 is modified by modifying the amount of the request retrieved at step S32 in the light of the partial satisfaction by the processing described above. That is, the amount is reduced by the value of the request at the head of the queue, and the request for a transfer of the reduced value is retained in the queue for processing.

From step S35 processing passes to step S36 where the request at the head of the queue is removed, given that it has been processed and satisfied. It is to be noted however, that the request is retained within the databases 13, 14 so as to provide an appropriate audit trail and satisfy applicable regulatory requirements. Steps S36a and S36b handle situations involving partial matches which are discussed further below. If it is the case that the full match was made only after a previous partial match, this is detected at step S26a and appropriate action is taken at step S36b. Processing passes from step S36b to step S37 where the parties are informed that the requests have been matched.

If the processing of step S34 determines that there is no full match (that is the request at the head of the queue is for an amount greater than the request retrieved at step S32), processing passes to step S38. Here the request retrieved at step S32 is marked to indicate that it is to be associated with the request at the head of the queue. An appropriate flag is set at step S39 (which is used at step S36a) to indicate that a partial match has been made, and the request at the head of the queue is modified (for the purposes of processing) at step S40 to indicate the amount of funds required to fully satisfy the request following the partial match. Processing then continues at step S41.

If no match is made at step S33 (for example because the request retrieved at step S32 relates to different currencies from that at the head of the queue), processing also continues at step S41.

At step S41 the pointer is incremented, and processing then moves to step S42 where a check is carried out to determine whether the end of the queue has been reached. If this is not the case, processing moves from step S42 to step S32 and continues as described above. In this way it can be seen that the request at the head of the queue is processed with respect to each other element of the queue in turn. If a full match is found, processing terminates in the manner described above, if a partial match is found, that match is marked for further processing.

When the end of the queue is reached, processing moves to step S43, where a check is carried out to determine whether the flag mentioned above has been set. If this is the case, the partial match associated with the flag is processed at step S44, and the parties are informed accordingly. At step S45 the head pointer is modified accordingly, so as to point to the next element of the queue. It will be appreciated that although the head pointer is moved, the previous head element may still exist if a partial match has taken place. In such a case the previous head element is processed during subsequent passes through the queue.

The description presented with reference to FIG. 11 has described a first in first out (FIFO) queue processing method in which requests are added to the tail end of the queue, and processing is carried out from the head end of the queue. The head element is processed with respect to other elements of the queue to identify a match or partial match and appropriate processing is carried out when a match is found.

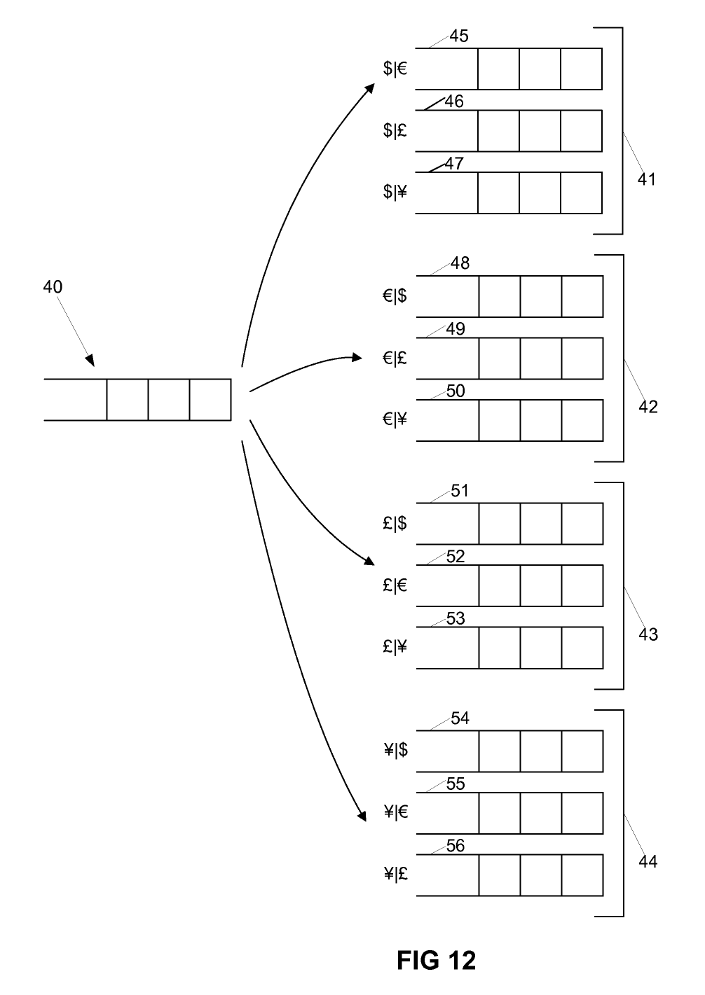

Alternative queuing methods can be as in a currency exchange process of the type described above. For example, with reference to FIG. 12, currency exchange request are initially placed in a source queue 40. This queue is operated in FIFO manner such that new requests are added to the tail of the queue whilst requests are removed from the head of the queue. When a request at the head of the queue is processed its source and destination currencies are determined with reference to appropriate data within the request. Such data determines how a request is processed.

It can be seen that the embodiment described with reference to FIG. 12 is concerned with exchanges between four distinct currencies, namely the US dollar, the Euro, the UK pound sterling, and the Yen. Accordingly, twelve queues representing various combinations of the four currencies are presented. The twelve queues are arranged in four groups. A first group 41 comprises three queues for requests having the dollar as their source currency. A second group 42 comprises three queues for requests having the euro as their source currency. A third group 43 comprises three queues for requests having the UK pound sterling as their source currency. A fourth group 44 comprises three queues for requests having the yen as their source currency. It can further be seen that the first group 41 comprises a queue 45 in which requests for currency exchange between the dollar and Euro are stored, a queue 46 in which requests for currency exchange between the dollar and pound are stored and a queue 47 in which requests for currency exchange between the dollar and Yen are stored. Similarly, the second group 42 has a queue 48 in which requests for exchange between the Euro and Dollar are stored, a queue 49 in which requests for exchange between the Euro and pound are stored, and a queue 50 in which requests for exchange between the Euro and Yen are stored. The third group 43 again comprises three queues, specifically a queue 51 in which requests for exchange between the pound and dollar are stored, a queue 52 in which requests for exchange between the pound and Euro are stored, and a queue 53 in which requests for exchange between the pound and Yen are stored. Group 44 also comprises three queues comprising a queue 54 in which requests for exchange between the Yen and Dollar are stored, a queue 55 in which requests for exchange between the Yen and Euro are stored and a queue 56 in which requests for exchange between the Yen and pound are stored.

Accordingly, it will be appreciated that a request at the head of the queue 40 is processed so as to determine a queue into which the request should be added based upon the source and destination currencies. In one embodiment the queues of the groups 41, 42, 43 and 44 are processed by a single process in a FIFO manner. Accordingly, a request at the head of one of the queues is selected for processing based upon time and date information within the request. When a request is selected for processing in this way an appropriate queue is then traversed from head to tail. That is, if it is determined that the request at the head of the queue 49 is to be processed, given that this request represents a request for transfer between the euro and pound, elements of the queue 52 are processed to locate one or more requests for currency exchange between the pound and the Euro which satisfy the request at the head of the queue 49.

It can then therefore be seen that the queuing system of FIG. 12 stores requests in a plurality of different queues and that processing can be modified accordingly.

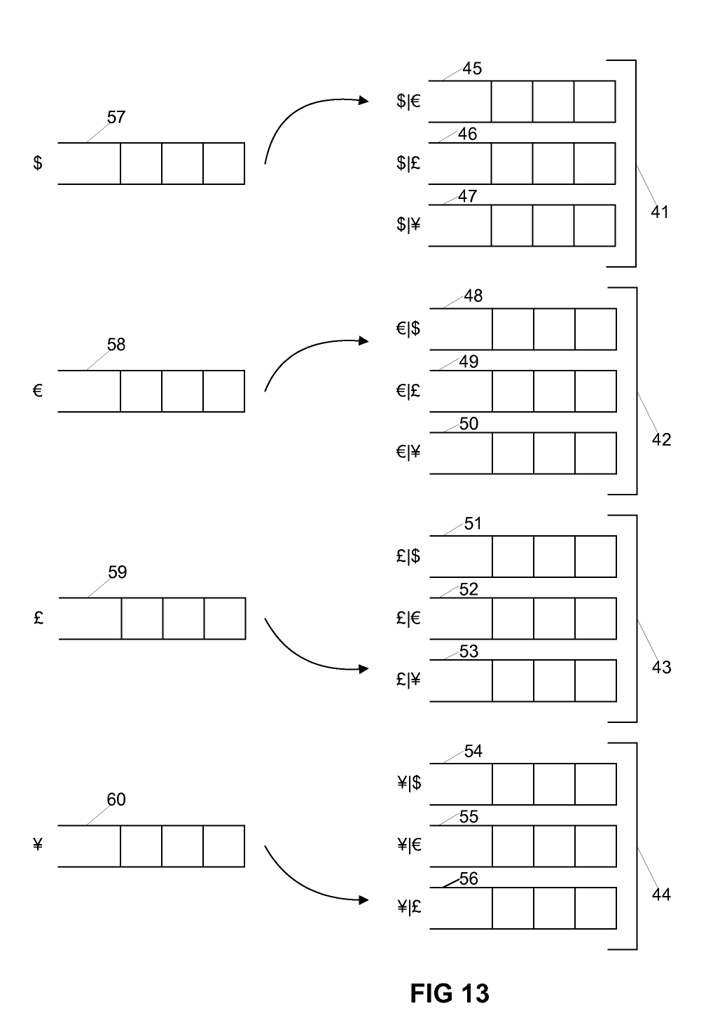

FIG. 30 shows are variant to the queuing method described with reference to FIG. 12. Specifically, here four source queues are provided comprising a dollar source queue 57, a Euro source queue 58 a pound source queue 59 and a Yen source queue 60. When a currency exchange request is received its source currency is determined and this determination allows selection of an appropriate source queue. For example, all requests for currency exchange from the Euro to another currency (regardless of what that other currency may be) are placed in the Euro source queue 58. The four source queues indicated above are preferably processed in an FIFO manner by a single process. That is, an element of the queues is selected for processing based upon time and date data stored within the requests. It can be seen that the queuing method of FIG. 13 again provides twelve queues for the various combinations of source and destination currency which are the same as the equivalent queues shown in FIG. 12. Here however it can be seen that all requests from the dollar source queue 57 will be placed in one of the queues of the first group 41, all the requests on the Euro source queue 58 will be placed in one of the queues of the second group 42, all requests from the pound queue 59 will be placed in one of the queues of the third group 43, while all of the requests from the Yen source queue 60 will be placed in one of the queues of the fourth group 44. Selecting an appropriate queue within an appropriate group involves determination of a destination currency for a particular request. That is, where an element of the pound queue 59 is processed it is necessary to determine whether its destination currency is the dollar, the Euro, or the Yen allowing selection of one of the queues 51, 52 or 53 respectively.

The preceding description has been concerned with FIFO queue processing methods it will however be appreciated that alternative queue processing methods can be used. For example, requests may be arranged in the various queues described above in order of value such that requests of high or low value (depending upon the ordering adopted) are processed preferentially.

The request priority 35 discussed with reference to FIG. 9 can also be used to affect the queuing mechanism. For example, requests may be allocated a relative priority based upon the user making the request. In that way requests from customers providing a large volume of requests may be processed in preference to requests from customers providing relatively few requests. Alternatively or additionally, the request priority may be determined based upon the geographical location of the user, such that requests emanating from particular geographical locations are processed in preference to requests from other geographical locations. Requests may also be prioritised based upon user preferences.

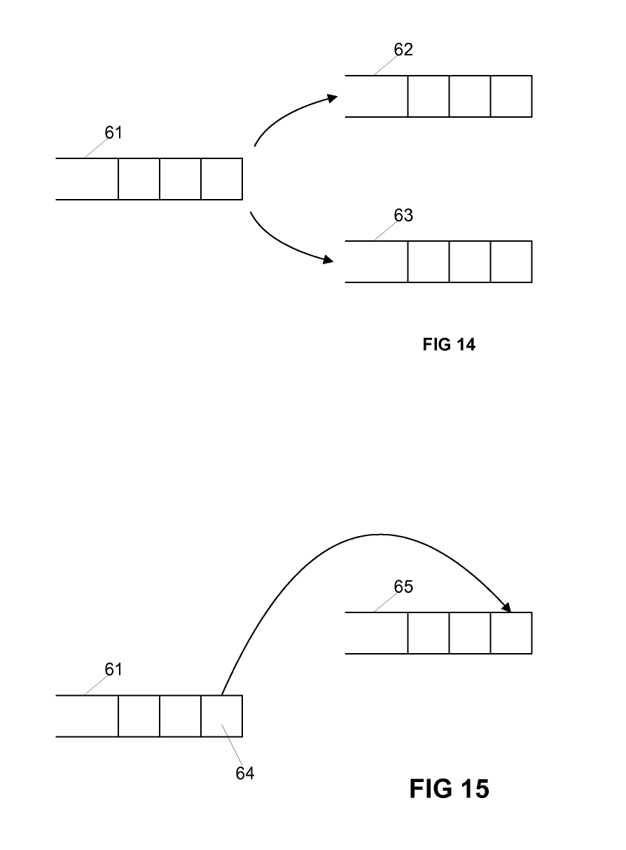

The queuing methods described above can also be varied in a number of ways. For example, any of the queues described above can be processed according to the method shown in FIG. 14. Here, elements of a source queue 61 are processed in an FIFO manner. When an element is processed its priority is determined. Requests having a priority higher than a predetermined threshold are placed in a first queue 62 while requests having a priority not higher then the predetermined threshold are placed in a second queue 63. The processing of requests within the queue 62 and 63 is arranged such that no element of the second queue 63 is processed while elements remain in the first queue 62. It can be seen that the arrangement of FIG. 14 is such as to allow effective prioritisation of requests having high priority. Such priority can be determined based upon characteristics of a request or characteristics of a user making such a request.

It will be appreciated that the method of FIG. 14 can be applied to the single queue of FIG. 10 as well as to any of the queues of FIGS. 12 and 13.

The description presented above with reference to FIG. 11 explains that where a request to the head of a queue could not be met processing moves to a subsequent request in the queue. FIG. 15 shows the method which can be used to handle such a situation. Specifically, where a head element 64 of the queue 61 cannot be matched the head element is moved to a buffer queue 65. When new currency requests are received and processed they are checked against entries in the buffer queue 65 before being processed in the manner described above. In this way requests at the head of the queue are given priority even when no match can initially be found.

It will appreciated that the queuing methods described above can be varied in a number of ways. Specifically, the user may specify that partial matches are not allowed such that only a request fully satisfying a request made by a particular user can be matched to that request. Similarly, where partial requests are allowed they can be processed in different ways. For example, in some embodiments each partial match may be processed as and when it is found, while in other embodiments partial matches are processed together when a number of partial matches satisfy an entire transaction have been located.

Users making requests using the system described above can make specifications as to the timing of the currency exchange transactions. For example, the reserved field 37 of the request shown in FIG. 9 may be configured so as to store a time at which the user would ideally like to effect the currency exchange. The system can use this time so as to aim to process the request at a specified time. Similarly, the reserve field 37 may be used to store exchange rate data. That is, while in a conventional system the exchanges described above are carried out at a prevailing exchange rate set by the system, the same exchange rate being applied to both parties to a matched transaction, users may specify that they are only interested in a match at a particular exchange rate. In this way the user is given considerable control over the match process and a system is provided in which currency exchange is effected only if a party can be found who is willing to effect a transaction at the specified exchange rate.

Where multiple queues have been described in the foregoing description, it has been indicated that all queues are processed by a single process. However, in some embodiments different queues may be processed by different processes, or alternatively by different threads within a process.

Although specific currencies have been indicated in the preceding description, it will be appreciated that the embodiments described above can be employed to effect currency exchanges between any currencies.

The accounts held within the system (as shown in FIG. 6 for example) may be implemented by way of one or more appropriate bank accounts held by an operator of the system at one or more banking establishments. That is, the operator of the system may hold the funds in trust for the parties to a transaction. Such bank accounts may comprise an account for each currency in which transactions are to take place. In some embodiments, bank accounts are held at banks in countries to which their currency is local. For example, a US dollar bank account is held with a US bank while a UK Pound Sterling bank account is held with a UK bank. Of course, it is not essential that bank accounts are arranged in this way.

In the preceding description reference has been made to funds being transferred between parties to a transaction. It should be noted that although such transfers take place, funds need not physically move between accounts. That is, funds may remain in a bank account held by the operator of the system, and the operator of the system simply holds the funds in trust for a different party after the transaction has taken place.

Various methods for effecting currency exchange have been described above. It will however be appreciated that the various modifications can be made within the spirit and scope of the present invention as defined by the appended claims.

1. A method for exchanging funds between currencies, the method comprising:
receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency;
storing said plurality of requests in a queue;
selecting a request for processing from said queue based upon queue processing data, wherein said selected request is said first request;
generating data indicating a match between said first and second requests;
transferring at least part of said first funds of said first currency directly from said first party to said second party; and
transferring at least part of said second funds of said second currency directly from said second party to said first party.

2. A method according to claim 1, wherein said queue processing data is arranged to cause selection of a request at a head of the queue.

3. A method according to claim 1, wherein said queue comprises a first in first out queue.

4. A method according to claim 1, further comprising:
ordering said requests in said queue based upon said requests;

5. A method according to claim 4, wherein said ordering is based upon a time at which said requests are made by respective users and/or a time at which said requests are received.

6. A method according to claim 4, wherein at least some of said requests comprise priority data, and said ordering is based upon said priority data.

7. A method according to claim 6, wherein said priority data for a request is at least partially based upon a user making the request.

8. A method according to claim 6, wherein said priority data for a request is at least partially based upon a geographic location of a user making the request.

9. A method according to claim 6, wherein said priority data for a request is at least partially based upon a value of said request.

10. A method according to claim 1, wherein said queue is a plurality of queues, the method comprising:
storing said plurality of requests in a primary queue; and
moving each of said requests to one of a plurality of second queues based upon data associated with a particular request.

11. A method according to claim 10, further comprising selecting one of said second queues to which a request should be moved based upon a source currency of said request.

12. A method according to claim 10, further comprising selecting one of said second queues to which a request should be moved based upon a destination currency of said request.

13. A method according to claim 10, wherein said plurality of second queues comprise a first relatively high priority queue and a second relatively low priority queue, and the method further comprises selecting one of said second queues to which a request should be moved based upon a priority of said request.

14. A method according to claim 1, wherein said queue is a plurality of queues, comprising a plurality of first queues and a plurality of second queues, and storing said requests in said queue comprises, for a particular request:
selecting one of said first queues in which said particular request should be stored;
processing said requests in each of said first queues to determine a second queue into which requests in said first queues should be transferred.

15. A method according to claim 14, wherein said first queue is selected based upon a source currency of the particular request.

16. A method according to claim 14, wherein said second queue is selected based upon a destination currency of the particular request.

17. A method according to claim 1, wherein said first request specifies a first amount in said first currency and said second request specifies a second amount in said second currency.

18. A method according to claim 17, further comprising:
processing said plurality of requests to determine a match between at least two requests.

19. A method according to claim 18, wherein said at least two requests comprise said first request and said second request.

20. A method according to claim 18, wherein processing said plurality of requests of requests to determine a match comprises determining:
(i) whether a source currency of a third request is a destination currency of a fourth request; and
(ii) whether a source currency of the fourth request is a destination currency of the third request.
and a match is determined if but only if conditions (i) and (ii) are satisfied.

21. A method according to claim 20, wherein said third and fourth requests specify corresponding amounts.

22. A method according to claim 21, wherein said corresponding amounts are specified in different currencies with reference to an exchange rate.

23. A method according to claim 18, wherein a third request is matched with a plurality of fourth requests.

24. A method according to claim 23 wherein said third request specifies an amount corresponding to an amount of said plurality of fourth requests.

25. A method according to claim 24, wherein said correspondence is defined with reference to an exchange rate.

26. A method according to claim 1, wherein said method is carried out by a server connected to a computer network.

27. A method according to claim 26, wherein said requests are transmitted to said server over said computer network.

28. A method according to claim 27, wherein said requests are generated by a plurality of user terminals connected to said computer network.

29. A computer program configured to cause a computer to carry out a method for exchanging funds between currencies, the method comprising:
receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency;
storing said plurality of requests in a queue;
selecting a request for processing from said queue based upon queue processing data, wherein said selected request is said first request;
generating data indicating a match between said first and second requests;
transferring at least part of said first funds of said first currency directly from said first party to said second party; and
transferring at least part of said second funds of said second currency directly from said second party to said first party.

30. A computer readable medium carrying a computer program according to claim 29.

31. A computer apparatus for exchanging funds between currencies, the apparatus comprising:
a program memory storing processor readable instructions; and
a processor configured to read and execute instructions stored in said program memory;
wherein said processor readable instructions comprise instructions controlling the processor to carry out a method for exchanging funds between currencies, the method comprising:
receiving a plurality of requests to exchange funds from one currency to another currency, the plurality of requests comprising a first request to exchange first funds of a first party in a first currency for funds in a second currency, and a second request to exchange second funds of a second party in said second currency for funds in said first currency;
storing said plurality of requests in a queue;
selecting a request for processing from said queue based upon queue processing data, wherein said selected request is said first request;
generating data indicating a match between said first and second requests;
transferring at least part of said first funds of said first currency directly from said first party to said second party; and
transferring at least part of said second funds of said second currency directly from said second party to said first party.

32. A computer apparatus according to claim 31, wherein said apparatus is a server computer connected to a computer network.

33. A computer apparatus according to claim 32, wherein a plurality of user terminals are coupled to said computer network.

34. A computer apparatus according to claim 33, wherein the plurality of user terminals provide said requests to said server computer.
